(19) United States
(12) Patent Application Publication
(10) Pub. No.: US 2003/0198751 A1
(43) Pub. Date: Oct. 23, 2003

(54) Method for reducing the occurrence of polymer strands on container ends

(76) Inventors: Robert B. Larsen, Maryville, TN (US); Thomas L. Levendusky, Greensburg, PA (US); Joseph D. Guthrie, Murrysville, PA (US)

Correspondence Address: ALCOA INC, ALCOA TECHNICAL CENTER, 100 TECHNICAL DRIVE, ALCOA CENTER, PA, 15069-0001, US

(21) Appl. No.: 10/127,312

(22) Filed: Apr. 22, 2002

(51) Int. Cl. B05D 3/02

(52) U.S. Cl. 427/385.5; 427/591

(57) ABSTRACT

A method to inhibit the formation of polymer strands on the edge of end panels and on the edge of spouts in container ends coated with thermoplastic polymers. The ends are heated sufficiently to induce crystallite formation in the thermoplastic polymer coating. Heating renders the coating less ductile, more brittle, less elastic and less prone to feathering and angel hair formation upon opening of container tabs.

### FIELD OF THE INVENTION

The present invention relates to a method for making food and beverage containers. More specifically, the invention relates to a method of making an aluminum-polymer composite end panel inhibited from producing polymer strands on the edges of container tab panels and container end orifices upon opening of a container.

### BACKGROUND OF THE INVENTION

Aluminum alloy containers used for food and beverage storage are commercially fabricated by forming a container body with an opening at the top of the body. An aluminum alloy lid or “end” is attached to the body, covering the opening in the body, to seal the container.

Ends for beverage containers are typically discs that have been stamped from aluminum alloy sheets coated with polymer. Coatings are applied to the metal sheet to improve preservation and taste characteristics of the food and beverages that will be stored in the containers. Coatings also improve the corrosion resistance, formability, and appearance of the metal. The polymer coating may be a thermosetting coating such as a polyvinyl chloride or an epoxy resin. Alternatively , the coating may be a thermoplastic material such as a polyester or a polyolefin. The thermoplastic coating can be applied by processes such as lamination and extrusion coating.

However, the highly ductile nature of thermoplastic polymers can lead to problems during the forming operations to make container ends for food and beverage containers. The first problem, called “feathering” or “membraning”, occurs when the extruded thermoplastic coating on the interior surface of the end separates from the metal when a pull tab or stay-on tab is used to open the beverage container. A thin sheet of the separated coating is visible, either partially covering the container orifice or projecting from the end panel. A second problem is called “angel hair”, in which polymer coating on the exterior surface of the end forms fine filaments when the stay-on-tab is used to open the end attached to the container body, or is present on the pull-off tab when this type of end design is used, thereby creating an undesirable appearance. It is possible for the fine coating filaments to enter the container through the spout opening in the container end or to enter the consumer's mouth when a consumer drinks from the container. Angel hair may also form at the peripheral edges of polymer coated metal disk blanks and at the top edges of polymer coated container bodies prior to container assembly.

Accordingly, a need exists for a polymer coated container end wherein the polymer has improved resistance to feathering and angel hair formation.

Thus, an object of this invention is to provide a method of making container ends that have improved resistance to interior polymer coating feathering, and have improved resistance to exterior polymer coating angel hair formation.

Additional objectives and advantages of our invention will become apparent to persons skilled in the art from the following detailed description of some particularly preferred embodiments.

### SUMMARY OF THE INVENTION

The invention provides a method to inhibit the formation of polymer strands on the edge of end panels and on the edge of orifices (i.e., spouts) in container ends coated with thermoplastic polymers. The method comprises heating the ends sufficiently to induce crystallite formation in the thermoplastic polymer.

The invention also provides a container comprising a body and an end attached to the body. The end is coated with a thermoplastic polymeric coating and has a separable end panel for opening the container. The end is thermally treated to induce crystallite formation in the thermoplastic polymer and to thereby inhibit the formation of polymer strands on the end and on the orifice in the end formed by separating the end panel from the end upon opening of the container.

Heating end thermoplastic polymer coatings, particularly coatings which are non-amorphous, but have few crystalline regions, increases polymer crystallinity in the coating , increases polymer brittleness, and decreases polymer ductility. Heating also provides improved adherence of the polymer coating to the end. Thus, heating of a polymer coating on an end inhibits feathering and angel hair formation during end opening. Although induction heating is preferred, the end coating can also be heated by convection heating to induce crystallite formation.

The invention has particular utility for reducing the occurrence of feathering and angel hair formation during the use of pull tabs and stay-on-tabs used for food and beverage containers.

### DETAILED DESCRIPTION OF PREFERRED EMBODIMENTS

The invention provides a method to inhibit the formation of polymer strands on the edge of end panels and on the edge of orifices in container ends coated with thermoplastic polymers. Aluminum alloys suitable for container end panels are provided as an ingot or billet or slab by casting. Before working, the ingot or billet is subjected to elevated temperature homogenization. The alloy stock is then hot rolled to provide an intermediate gauge sheet. For example, the material may be hot rolled at a metal entry temperature of about 700°-950° F. to provide an intermediate product having a thickness of about 0.1.25 inch to about 0.190 inch. This material is cold rolled to provide a sheet ranging in thickness from about 0.007 to 0.014 inch. AA5182 and AA5042 alloys are preferred alloys for use in this invention. AA5182 aluminum alloy sheet, in either the H19 or H39 temper, is particularly preferred.. Another particularly preferred metal sheet is AA5042 aluminum alloy sheet in the H2E72 temper.

The aluminum alloy end panel sheet is preferably cleaned with an alkaline surface cleaner to remove any residual lubricant adhering to the surface and then rinsed with water. Cleaning may be avoided if the residual lubricant content is negligible.

A conversion coating may also be applied to the sheet to assure good adhesion of the polymer coating and to improve corrosion resistance. Both chrome-containing and chrome-free conversion systems are suitable. The chrome conversion coating generally contains a chromate and a phosphate. Some non-chrome conversion coatings are solutions containing zirconate, titanate, molybdate, tungstate, vanadate, and silicate ions, generally in combination with hydrogen fluoride or other fluorides. The conversion coated sheet may be rinsed with water and then dried before a polymer coating is applied. Preferred conversion coatings include chromium phosphate conversion coatings or non-chrome coatings as described in U.S. Pat. Nos. 6,020,030 or 6,030,710.

The end panel sheet is then coated with a thermoplastic polymer. Suitable polymer coatings for use in this invention are polyethylene terephthalate, polyethylene terphthalate copolymers, blends of polyethylene terphthalate homopolymers with polyethylene terphthalate copolymers, or the polyolefins, in particular polypropylene copolymers. The preferred thermoplastic polymers are blends of polyethylene terphthalate homopolymers with polyethylene terphthalate copolymers. The polymer coating may also optionally contain additives such as dyes, pigment particles, anticorrosion agents, antioxidants, adhesion promoters, light stabilizers, lubricants, and mixtures thereof.

The thermoplastic polymer coating can be applied to the end sheet material by processes such as lamination and extrusion coating. Extrusion coating is particularly preferred for use in this invention. The polymer coating is preferably extruded onto the sheet as a single layer. Preferably, both sides of an aluminum alloy sheet are extrusion coated with a thermoplastic polymer coating leaving a thickness of about 0.04-0.5 mils (1-13 microns). A polymer coating having a thickness of about 0.4 mils (10 microns) is particularly preferred for end interiors. A polymer coating of about 0.2 mils (5 microns) is particularly preferred for end exteriors.

Container ends are stamped or cut from the polymer coated metallic sheets. The circumference of each end panel is slightly larger than the circumference of the opening in the container body to allow the end panel to be joined to the body by double seaming. Various techniques for forming contours and shapes on the ends to facilitate attachment to container bodies are well known in the art. Easy open end panels for carbonated beverages are generally shaped by stamping metal blanks between shaping dies.

The inventors have discovered that extruded thermoplastic polymers on container ends often lack crystalline regions and are in an nearly amorphous, partially crystalline state. The inventors believe that the lack of crystallite regions in the extruded thermoplastic polymer contributes to the ductility and elasticity of the polymer resulting in the polymeric coating being suitable for end fabrication. During the end conversion processes (i.e. extrusion coating, quenching, and shaping), the polymer coating is not exposed to sufficient heating to result in the formation of additional crystallite regions within the polymer. Thus, the coating remains ductile and elastic. However, the inventors also believe the same ductility and elasticity also contributes to the formation of angel hair and feathering upon opening of container end panels.

The inventors believe that heating the end causes crystallite formation, which renders the polymer more brittle, less ductile and therefore less prone to the formation of angel hair and feathering upon opening of container end panels. The amount of heating that is sufficient to form crystallites will depend on a number of factors such as the composition of the coating, the thickness of the coating, the amount of crystallite formation that has already occurred within the coating, the rate of heating and cooling the coating experiences and the like.

It is necessary to heat a coatings above the glass transition temperature (Tg), and to maintain temperature for a sufficient period of time so that crystal growth occurs in the coating. The longer the coating is held at the crystal formation temperature, the greater the percentage of crystallite growth in the coating.

Heating methods can include thermal convection or induction methods, with induction heating being the preferred method. Induction heating is performed by positioning an inductor coil over the scored portion of the converted end, and passing alternating electric currents through the coil. The energized coil causes the thermoplastic polymer within the score region on the exterior of the end and the thermoplastic polymer on the interior surface of the end to experience eddy currents which raise the temperature of the thermoplastic coating. The end is then held above the glass transition temperature of the coating, but below the melting point of the coating, to increase the level of crystallinity in the coating.

The inventors believe that temperatures of 150-180° F. (66-82° C.) for periods of 1-30 seconds and preferably 2-10 seconds, are sufficient to inhibit the formation of angel hair and feathering upon opening of container tab panels for partially crystalline polyester polymers.

The foregoing disclosure of our invention has been made with reference to some particularly preferred embodiments. Persons skilled in the art will understand that numerous changes and modifications can be made without departing from the spirit and scope of the following claims.

We claim:

1. A method to inhibit the formation of polymer strands on a container end having a panel and a panel orifice, said end coated on at least one surface with a thermoplastic polymer coating, said method comprising heating said container end sufficiently to induce crystallite formation in said thermoplastic polymer.

2. The method of claim 1 wherein said thermoplastic polymer is a polyester or polyolefin.

3. The method of claim 1 wherein said thermoplastic polymer is selected from the group consisting of polyethylene terephthalate, polyethylene terphthalate copolymers, mixtures of polyethylene terphthalate homopolymers with polyethylene terphthalate copolymers, and polypropylene copolymers.

4. The method of claim 1 wherein said heating is convection heating or induction heating.

5. A method of making a thermoplastic polymer container end coating having improved resistance to feathering and angel hair formation, said method comprising heating said coating sufficiently to induce crystallite formation in said coating.

6. The method of claim 5 wherein said thermoplastic polymer is a polyester or polyolefin.

7. The method of claim 5 wherein said thermoplastic polymer is selected from the group consisting of polyethylene terephthalate, polyethylene terphthalate copolymers, mixtures of polyethylene terphthalate homopolymers with polyethylene terphthalate copolymers, and polypropylene copolymers.

8. The method of claim 5 wherein said heating is convection heating or induction heating.

9. A container comprising:
(a) a cylindrical body; and
(b) an end attached to said body, said end coated with a thermoplastic polymeric coating selected from the group consisting of polyethylene terephthalate, polyethylene terphthalate copolymers, mixtures of polyethylene terphthalate homopolymers with polyethylene terphthalate copolymers, and polypropylene copolymers, said end having a separable end panel and an end orifice corresponding to said end panel, wherein said end is thermally treated to induce crystallite formation in said thermoplastic polymer and to inhibit the formation of polymer strands on said end panel and on said end orifice upon separation of said end panel from said end.

10. The method of claim 9 wherein said thermal treatment is convection heating or induction heating.

11. A method of making a metal-thermoplastic polymer composite container end wherein said end has improved resistance to feathering and to angel hair formation, said method comprising heating said end sufficiently to induce crystallite formation in said polymer.

12. The method of claim 11 wherein said thermoplastic polymer is a polyester or polyolefin.

13. The method of claim 11 wherein said thermoplastic polymer is selected from the group consisting of polyethylene terephthalate, polyethylene terphthalate copolymers, mixtures of polyethylene terphthalate homopolymers with polyethylene terphthalate copolymers, and polypropylene copolymers.

14. The method of claim 11 wherein said heating is convection heating or induction heating.
